(19) United States
(12) Patent Application Publication
(10) Pub. No.: US 2012/0200780 A1
(43) Pub. Date: Aug. 9, 2012

(54) SYSTEMS, METHODS, AND OPERATION FOR NETWORKED VIDEO CONTROL ROOM

(76) Inventor: Eli DORON, Ganei Tikva (IL)

(21) Appl. No.: 13/366,397

(22) Filed: Feb. 6, 2012

Related U.S. Application Data
(60) Provisional application No. 61/439,867, filed on Feb. 5, 2011.

(51) Int. Cl. H04N 5/262

(52) U.S. Cl. 348/722; 348/E05.051

(57) ABSTRACT

A system comprising a network control room accessible by at least one control room operator via input-output equipment, for generating at least one audiovisual data stream for reception by at least one internet enabled viewing device over a network.

### CROSS REFERENCE TO RELATED APPLICATIONS

This application claims the benefit of U.S. Ser. No. 61/439,867, filed on May 5, 2011, which is incorporated in its entirety herein by reference.

### FIELD OF THE INVENTION

The present invention generally relates to generating live and on demand video content and, more particularly, to generating and providing distributed, or network-based, video content to viewers over the Internet.

### BACKGROUND OF THE INVENTION

Traditionally television has been broadcast over the airwaves. With the digital revolution and developments such as fiber optic cable, television may now be streamed to users down fibers such as phone lines, or from satellites. These technologies enable more data to be received than that available via traditional aerials. Consequently, and special interest groups may now have dedicated content transmitted to them. A dedicated group may be characterized by a common specific and narrow geographic location, allowing local community television, or may be characterized by a common interest, and may be widely separated geographically.

Community Access (or Antenna) Television (CATV or “cable”) were early examples of communities serviced by modern dedicated transmissions, that were not previously serviced by radio frequency (RF) broadcasting of television signals. Although CATV was based on analog technology and used a broad spectrum of analog channels (broadband), it nevertheless successfully demonstrated the economic efficacy of network television distribution. Eventually cable operators converted their systems to hybrid-fiber coax (HFC) technology that combined digital and analog distribution technologies, thereby enabling them to greatly expand the range and quality of services they offered. Geostationary satellites with digital broadband broadcast capabilities were placed in orbit, primarily over the lucrative markets of North America and Europe.

Nevertheless, in spite of the myriad of channels offered by the cable and satellite television operators, there are two significant deficiencies associates with the strategies employed by both satellite and cable television: (i) the scheduling is determined by the broadcasters and not by the recipients, and (ii) the content is generally aimed at maximizing ratings, and consequently does not provide a solution for niche fields of interest. Each of these deficiencies is a consequence of television subscription, which typically offers limited audio visual content via select channels, thereby enabling the network operators to control viewer access to content, deciding what content to provide, based on their perception of what is of interest to most viewers. Specialist content that may be of interest to smaller group of viewers is rarely broadcast. By exercising control over what is broadcast, network operators gain control over both users and content providers. However, with the digital era of television distribution, the ability to micro-target advertising to specific locations has become possible, allowing the same time slot to be used for transmitting different advertisements to different audiences.

Whereas in the past, a broadcast television station was given a metro-regional charter and advertising by the stations was seen throughout the reception area of that station, as television signal distribution became more digital and more cable or wire oriented, it became possible to sectionalize the audience to a much greater extent, up to the level of the individual television set. The impact has been positive on both advertisers and broadcasters alike. The number of advertisers interested in advertising within a given 30 seconds of television broadcasting has grown, while the advertisements themselves are more targeted, resulting in improved impact.

New TV sets often have direct connection to the Internet, which may be either wired or wireless. Such TV sets are often referred to as Connected TV. Connected TVs, manufactured by companies such as Sony and Samsung have already achieved market presence and other vendors are expected to follow.

For TV viewers without Connected TV, the same functionality may be provided by a set top box that connects on one side to the Internet and to the TV on the other side. Examples of Set top boxes of this type include Apple TV, Boxee and Google TV based the Logitech Revue. Logitech revue provides as an option to add an HD camera for home video content streaming. A special segment of the set top boxes are the game consoles such as PS3, Wii and Xbox 360. In addition to the Connected TV and the Set top box, computers, iPads and other devices with Internet connectivity and video display capability may receive audiovisual stream of video as well. In addition computers, tablets and cellular phones are also connected to the internet with an ability to display stream of video content.

### SUMMARY OF THE INVENTION

A first aspect of the invention is directed to providing a system comprising a network control room accessible by a control room operator via input-output equipment, for generating audiovisual data streams for reception by internet enabled viewing devices over a network.

Typically the network is an internet.

In the various embodiments, the network control room is either supported at a single location or is distributed over a plurality of data centers.

In the various embodiments, functional components are coupled by data links (channels) selected from the group comprising fiber-optic lines, copper lines, coaxial cables, radio channels, cellular channels, satellite channels and RF links.

Preferably, the network control room is able to access data from at least one video content archive.

Most preferably, the video content archive is configured to provide data selected from the group comprising audio visual data, display information and supplementary information.

Typically, the system further comprises at least one video camera selected from the group comprising studio cameras, home cameras, field cameras.

Typically, audiovisual, audio and visual data is provided in at least one format selected from the group comprising streamed data and data files.

Generally, audiovisual, audio and visual data is provided either compressed or uncompressed.

Preferably, the network control room is in data communication with and able to access commercial content from a commercial content archive.

Typically, the system further comprises a television (TV) studio.

Typically, the TV studio comprises at least some of the group comprising a media processing unit, a prompter, a monitor, speakers, earphones, and lighting.

Optionally, the media processing unit is in data communication with at least one of the group comprising studio cameras and microphones.

Typically, the media processing unit comprises a communication module in data communication with one or more video encoders, audio encoders, video decoders, audio decoders and controllers.

Typically, the network control room comprises at least one communication module coupled via video and audio codecs to video and audio mixers, at least one controller, recorder, encoder, distributer, graphic effect generators, local content storage modules, and character generators.

Preferably the system further comprises at least one operator's control room coupled via a data link to the network control room, said operator's control room for enabling an operator to control the system, via at least one operator input output device coupled to a control unit.

It will be appreciated that the word ‘room’ is used here rather loosely, and relates to a virtual location, not a physical room.

Optionally, the operator's control room may be distributed between multiple locations, which may be real or virtual, and operated by one or several operators.

Preferably the operator's control room further comprises at least one of the group comprising headphones, camera, display, audio codec, video codec, data module, and communication module.

Typically, the at least one operator input output device is selected from the group comprising keyboards, computer mice, touch screens, displays, cameras with gestures, 3d devices and light indicators.

A second aspect of the invention is directed to providing a TV studio controlled over a network from a network control room, the TV studio comprising at least some of the group comprising a media processing unit, prompters, monitors, speakers, earphones, and lighting.

Typically, the media processing unit is in data communication with at least one of the group comprising studio cameras and microphones.

A third aspect of the invention is directed to providing an operator's control room coupled via a data link to a network control room, said operator's control room for enabling an operator to control the network control room, via at least one operator input output device coupled to at least one control unit.

Typically, the operator's control room further comprises at least one of the group comprising headphones, cameras, displays, audio codecs, video codecs, data modules and communication modules.

The term link, communication channel, data link and connection are used interchangeably to imply a data communication channel that may be fixed or created on the fly over a network, and may be wired or wireless.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic functional block diagram illustrating an exemplary network-based video production system in accordance with an embodiment;

FIG. 2 is a schematic functional block diagram illustrating an exemplary studio in accordance with an embodiment;

FIG. 3 is a schematic functional block diagram showing a media processing unit of the studio, showing the communication module and surrounding equipment;

FIG. 4 is a functional block diagram illustrating an example of the network control room used in the system of FIG. 1;

FIG. 5 is a schematic functional block diagram illustrating the operator's control room functions, and

FIG. 6 is an example of a display combined from multiple video sources.

### DETAILED DESCRIPTION OF THE EMBODIMENTS

The present invention is directed to providing network-based video content to internet connected devices such as television, tablets, computers and cellular phones, for example.

Software for providing network-based video and audio (voice) signals over television provides a graphical user interface (GUI) to an operator that essentially serves as a TV director or TV producer. Subsequently, in response to input through the GUI, the software is able to identify a plurality of remote video content providers and to provide a video stream that combines signals from one or more of the remote video content providers over the network to the television. The software may be communicably coupled with a central or distributed repository that stores information associated with a plurality of remote video content providers. Software associated with the repository may query the repository in response to a request from the operator. The remote video content may include live events and/or stored events.

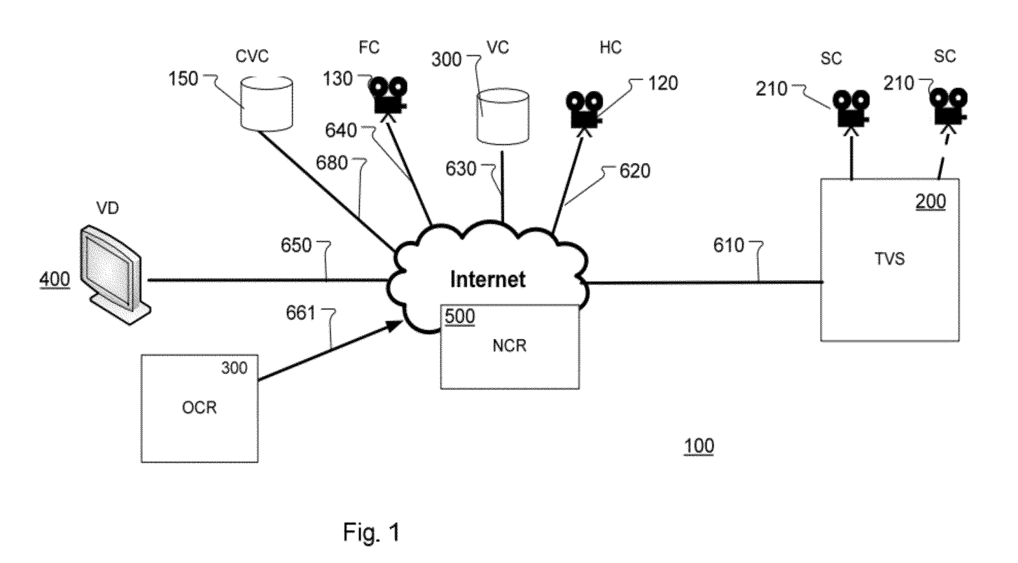

With reference to FIG. 1, a block diagram illustrating an exemplary system 100 in accordance with one embodiment is shown. The system 100 includes a network control room 500 and allows the identifying, providing and otherwise managing network-based audiovisual programming. The system 100 generates video streams that are viewable on televisions and other internet connected devices 400. For example, the system 100 may be able to access a TV studio 200 to receive audio visual streams over data link 610 as generated by one or more TV cameras 210, either located in the studio 200 or outside 210 the studio 200. The audio visual data streaming over the link 610 may be provided in a compressed or in an uncompressed form. The link 610 may be a wire-line channel such as a fiber optic or copper cable, or the like, or may be provided as a wireless channel, such as a satellite channel, a cellular or other RF signal. In general, data links used by the system 100 may be dedicated channels or non dedicated ones, such as used on public networks, for example.

In addition, system 100 may access a field camera 130. The field camera 130 will be connected via a data link 640, which may be a fiber-optic line, a copper line, a radio channel, a cellular or satellite channel, for transmitting an audiovisual stream thereby. The audiovisual stream from the field camera 130 may be provided in compressed or uncompressed form.

Furthermore, system 100 may optionally include one or more home cameras 120. For transmitting an audiovisual stream, the home camera 120 may be connected via a connection or link 620, which may be a fiber optic line, copper line, radio channel, cellular or satellite channel. The audiovisual stream from the field camera 130 may be provided in compressed or uncompressed form.

System 100 may additionally be configured to access one or more video content archives 180. The video content archive 180 is accessible over a connection (i.e. Data link) 630 for transmitting audio visual data and additional data such as display information, supplementary information and the like, relating to the audiovisual data. Audiovisual data may be provided as a ca stream or as a file, and may be compressed or uncompressed. If more than one video content archive 180 is provided, they may be located in one geographic location or at multiple locations, belonging to the same or to different owning domains.

Furthermore, in some embodiments, system 100 may access one or more commercial content archives 150 via a connection 680 for transmitting audio visual data and additional data that relates to the audiovisual data. Again, it will be appreciated that audiovisual data may be provided as a stream or as a file, and may be compressed or uncompressed. Where more than one commercial content archives 150 are provided, they may be located in one geographic location or at multiple locations belonging to the same or different owning domains.

System 100 includes a network control room 500. The network control room 500 is a generally provided as a software application that may be supported by a single server or data center, or, in distributed form, on a plurality of data centers that may be located at one or in a plurality of geographic areas across the globe. All audio, visual or audiovisual data received through any connection 610, 620, 630, 640, 661 and 680, are transmitted to the network control room 500. A function of the network control room 500 is to generate audiovisual streams that are distributed via links 650 of the network to viewing devices 400 and via a data link 661 to an operator's control room 300.

The viewing device 400 may be any type of internet browser, including a TV with direct connection to the internet, a set top box that is connected to the TV and to the internet 600 or a computer, tablet or a cellular phone connected to the internet. The various viewing devices 400 may access the internet 600 over a wire and/or over a wireless link 650. It will be appreciated that although only one is depicted, typically, several viewing devices 400 are provided. Link 650 may carry one audiovisual format or multiple audiovisual formats, depending on the specific characteristics of viewing device 400.

All cameras (210, 120, 130) transmit a data stream that may include audio, video and meta data.

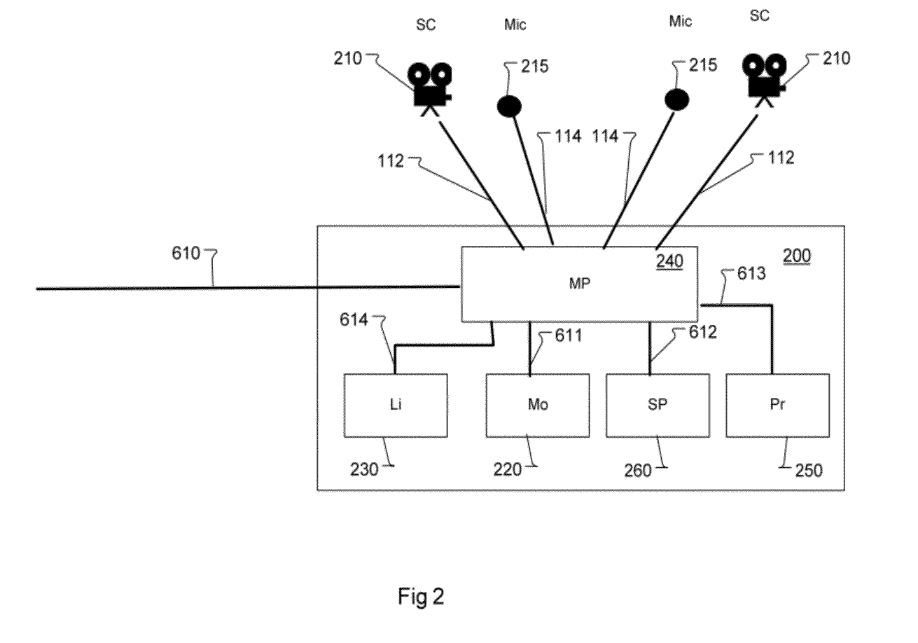

With reference to FIG. 2, a generalized functional description of a TV studio 200 is now provided. Associated with the TV studio 200 are one or more studio cameras 210. The studio cameras 210 transmit video signals over a link 112. The cameras 210 may be manually operated and/or may have automatic pan-tilt-zoom capability (PTZ). PTZ control may be manually provided locally, or over the network by a remote operator. The video signal from the studio camera 210 may be provided in any or several video formats, such as PAL, NTSC, SECAM and digitally HD in various resolutions and frame rates. The TV studio 200 may also have one or more microphones 215 associated therewith for transmitting an audio signal over an appropriate data link 114. It will be appreciated that as with the video signals provided by the camera 210 and the various audio signals may also have different characteristics. It will further be appreciated that the links 112, 114 may be dedicated or general purpose data links, may, in general, be cordless or hard wired, analog or digital, and may use a wide variety of technologies, including, inter alia RF, IR, coax, electro-optic, or copper wire.

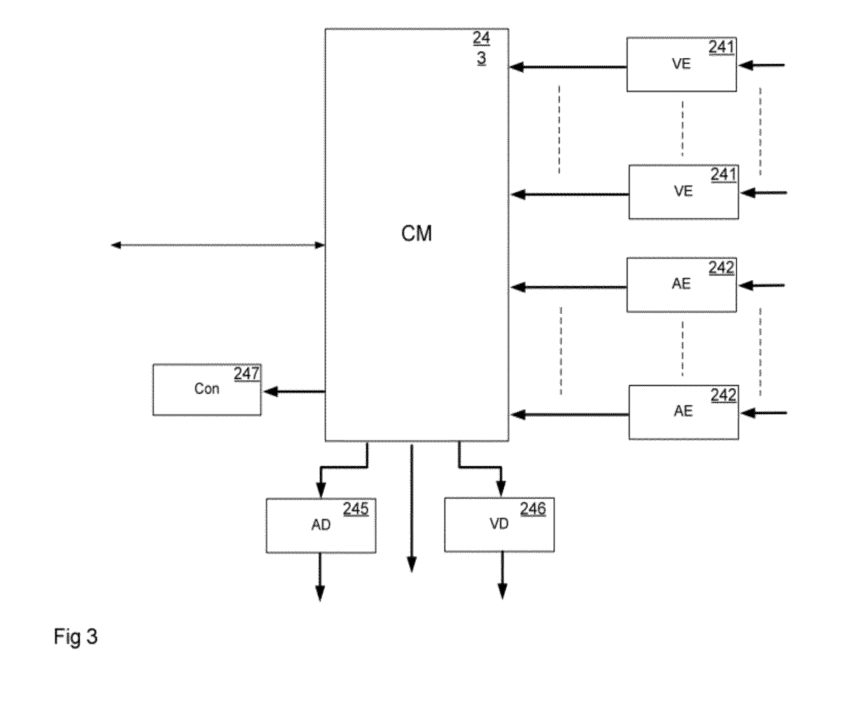

A media processing unit 240 for processing the video and the audio signals is provided. A detailed description of the media processing unit 240 is provided herein below with reference to FIG. 3.

Optionally, one or more monitors 220 are configured for receiving video signals 611 from the media processing unit 240. The source of the video signals 611 may be the cameras 210 of the TV studio (which themselves, may be deployed internally or externally to the studio, or video received from the internet 600 via a connection 610 which also provides a control signal from the network control room 500, concerning what to display.

Optionally, a headphone or speakers 260 are configured to receive audio signals 612 from the media processing unit 240. Audio is receivable via connection 610 from the network.

Furthermore, the TV studio 200 may be provided with a prompter 250, for receiving text signals 613 from the media processing unit 240 or from outside the TV studio 200 via connection 610.

One or more lights 230 may be provided. Such lights 230 may receive control signals 614 from the media processing unit 240. Control of the lighting may be received from the network control room 500 via connection 610.

With reference now to FIG. 3, the media processing unit 240 within the TV studio 200 is now described in more detail. The media processing unit 240 receives video signals over link 112 from the cameras 210, using a video encoder 241 to encode the signals. In some embodiments, the video encoder 241 passes the video signals through link 113 to the communication module 243 without first compressing them.

The media processing unit 240 may receive audio signals via link 114 from the microphone 215 and may use an audio encoder 242 to encode the signal. The audio encoder 242 may pass audio signals received through link 114 via output of the audio encoder 242 through link 115 to the communication module 243. In some embodiments, the audio encoder 242 does not compress the data outputted.

The communication module 243 may be configured for receiving video and audio signals via incoming links 113, 115 and for packing them for transmission over the communication channel 610. Packetization may be accomplished using any appropriate standard protocol, or a proprietary one. The communication module 243 may also receive incoming packetized signals through the communication channel 610. The signals received may contain compressed and/or uncompressed video, audio, data and/or control signals. The communication module 243 unpacks the signals received and then, if it is compressed, the video signal 116 is then decompressed by the video decoder 246.

With reference to FIG. 2, the signals may be sent to the monitor 220 over connection 611. Audio signals sent via link 117 may be decoded by the audio decoder 245 and transmitted via connection 612 to the headphones/speakers 260. Data signals may be transmitted to the prompter 250 via connection 613.

Control signals may be sent via link 118 to the controller 247 for controlling the encoders (e.g. Encoder 242), decoders (e.g. Decoder 246), cameras (e.g. Camera 210) and lights (e.g. Light 230) or any other devices that require controlling.

Although an embodiment with one studio is described, it will be appreciated that in other embodiments, there may be several studios in the system.

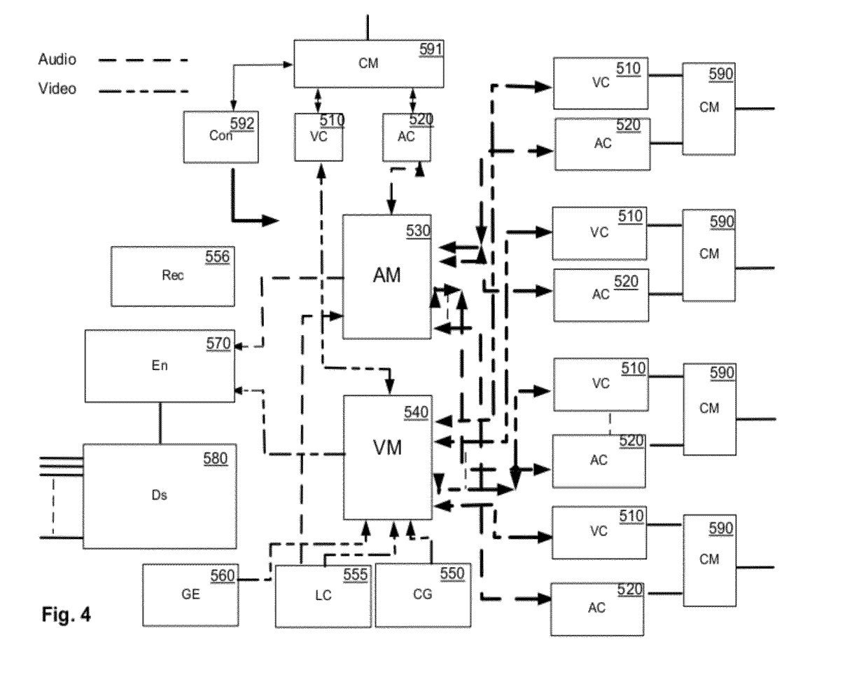

FIG. 4 is a block diagram illustrating the main elements of the network control room 500 in a generalized embodiment. An incoming connection 610 from the studio 200 enters the communication module 590 which separates incoming signals into video signals that are directed to the video decoder part of the video codec 510 and audio signals that are directed to the audio decoder part of the audio codec 520. The video decoder part decompresses the video signal if is compressed and simply passes it along if it is not compressed Likewise, the audio decoder part decompresses the audio signal if is compressed and passes it along if it is not compressed.

One or several communication modules 590 may be provided. Similarly, one or more video codec 510 and one or more audio codecs 520 may be provided.

The connection 620 from the home camera 120 enters the communication module 590 which separates the incoming data and the video signals are directed to the video decoder of the video codec 510 and the audio signal to the audio decoder of the audio codec 520. The video decoder decompresses the video signal if is compressed and simply passes it along if it is not compressed. The audio decoder decompresses the audio signal if is compressed and simply passes it along if it is not compressed.

Referring back to FIG. 1, the connection 630 from the video content archive 180 enters the communication module 590 that separates the video signal to the video decoder of the video codec 510 and the audio signal to the audio decoder of the audio codec 520 if it is provided as a data stream. The video decoder decompresses the video signal if is compressed and passes it through if it is not compressed. The audio decoder decompresses the audio signal if is compressed and passes it through if it is not compressed. If the content received over connection 630 is a file it is stored in the local content storage memory 555.

The connection 640 from the field camera 130 enters the communication module 590 that separates the video signal to the video decoder of the video codec 510 and the audio signal to the audio decoder of the audio codec 520. The video decoder decompresses the video signal if is compressed and passes it through unchanged if it is not compressed. The audio decoder decompresses the audio signal if is compressed and passes it through if it is uncompressed.

The uncompressed video passing through links 664 from video sources and the uncompressed audio data from links 663 from all audio decoders are fed to the video mixer 540 and audio mixer 530 respectively.

The audio mixer 540 receives additional audio signals from the operator's control room 300 after it was extracted from the connection 661 by the communication module 591 and the decoder in the audio codec 520. The audio mixer 540 receives additional audio signals from the local content database 555 through connection 678.

The audio mixer 540 sums the audio signals from the various sources and generates one or more audio signals that are essentially mixes of some or all of the audio inputs. Mixed audio signals are fed back to the audio encoder of all or some of the audio codec 520 modules. One of the outputs of the audio mixer 540 is fed to the audio encoder part of encoder 570.

The video mixer 540 may receive additional video signals from the control room operator 300 after extraction from connection 661 by the communication module 591 and decoder in video codec 510 through connection 677, and from the character generator 550 via connection 667, from the graphic effect module 560 via connection 668 and from the local content database 555 via connection 669. The video mixer 540 may generate one or more pictures that are constructed from all or part of the video inputs. It will be appreciated that the layout and location of the video sources and other control parameters are part of the control signals received from the control module 592. Mixed video signals may be fed back to the video encoders of some or all of the video codec 510 modules. One of the outputs of the video mixer 540 may be fed to the video encoder part of encoder 570.

Encoder 570 may generate one or more audio/video signals which optionally include different resolutions, frame rates and other parameters. These signals may be fed over connection 676 to the distribution module 580 or distributer, which, based on control signals received from the control module 592, may stream audio/video signals over connections 660 to viewing devices 400. Connections 660 may provide one or multiple data streams.

The local content database 555 enables non linear video to be mixed or displayed with the live, linear video signals received from the other modules. The local content database 555 may contain various types of video including, for example, pre-recorded events, commercial advertisements and computer animated video.

The recorder 556 may record any event within the network control room 500 including audio, video, data and control from any of the modules in the network control room 500.

The control module 592 may receive control messages from the operator's control room 300 through connection 661 to the communication module 591 that extract the control messages. Control module 592 may control all modules and elements in the network control room 500.

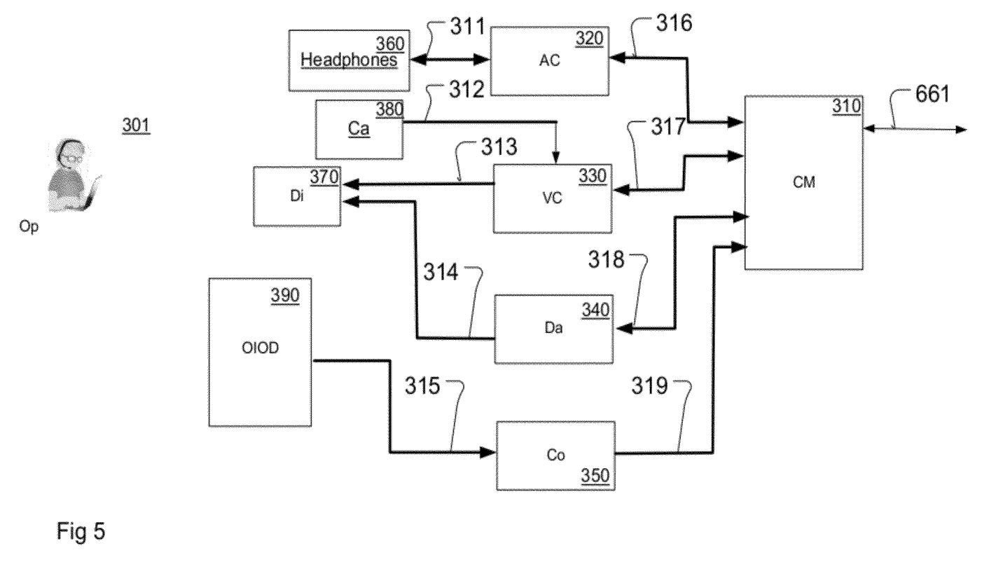

FIG. 5 is a generalized functional block diagram illustrating the modules of the operator's control room 300. As will be appreciated, in specific embodiments, there may be one or more operator's control rooms 300, located in one or multiple locations. Each operator's control room 300 may contain various modules, including communication modules 310, data module 340, control modules 350, one or more cameras 380 coupled via video codecs 330 which are also connected to one or more displays 370, and which also receive data over link 314 from the data module 340, headphones 360 coupled via audio codec 320. The control module 350 may be coupled via link 315 to one or more operator input/output devices 390, for interaction from an operator 301.

Through connection 661, the communication module 310 may transmit voice, video data and control to the network control room 500. The communication module 310 may separate the received signal to audio signal that is sent to the audio decoder part of the audio codec 320, to the video signal that is sent to the video decoder part of the video codec 330 and to the data module 340. The communication module 310 may combine audio signals that may be received from the audio encoder part of the audio codec 320, with video signals that may be received by the video encoder part of the video codec 330, and with data that may be received from the data module 340 and/or from the control module 350.

The audio encoder may compress audio signals received over link 311 from the microphones or headphones 360 and the audio decoder 310 may decompress audio signals received via link 316 from the communication module 310 and may sends them to the speakers or earphones 360 via link 311.

The video encoder of video codec 330 may compress video signals 312 received from the camera 380 and the video decoder 320 may decompress video signals 317 received from the communication module 310 and send them to the one or more displays 370 via connection 313.

Data extracted from the communication module 310 may be sent via signal communication link 318 to the data module 340. Data generated by the data module 340 may be sent to the communication module 310 using the same communication link 318. It will be appreciated that data received via channel 314 may be displayed on one or more displays 370.

Control signals generated by the control module 350 may be sent to the communication module 310 via link 319. Such control signals may be generated responsive to inputs received from the operator's input/output devices 390 via communication link 315.

Input/output devices 390 may include a variety of hardware elements such as keyboards, computer mice, touch screens, displays, cameras with gestures, 3D devices, light indicators, etc.

A human operator 301 may use the input/output devices 390 to operate the whole operator's control room 300, deciding what will be displayed, what will be heard and providing instructions and control thereby to all the units in the studio, to the home cameras 120, the field cameras 130 and other elements of the system 100.

It will be appreciated that more than one operator 301 may each be responsible for different parts of the control.

Via the operator's control room 300, one or more operators 301 may be able to insert commercials into the data stream in real time. The operators 301 may alternatively signal the location and time for insertion of the commercial.

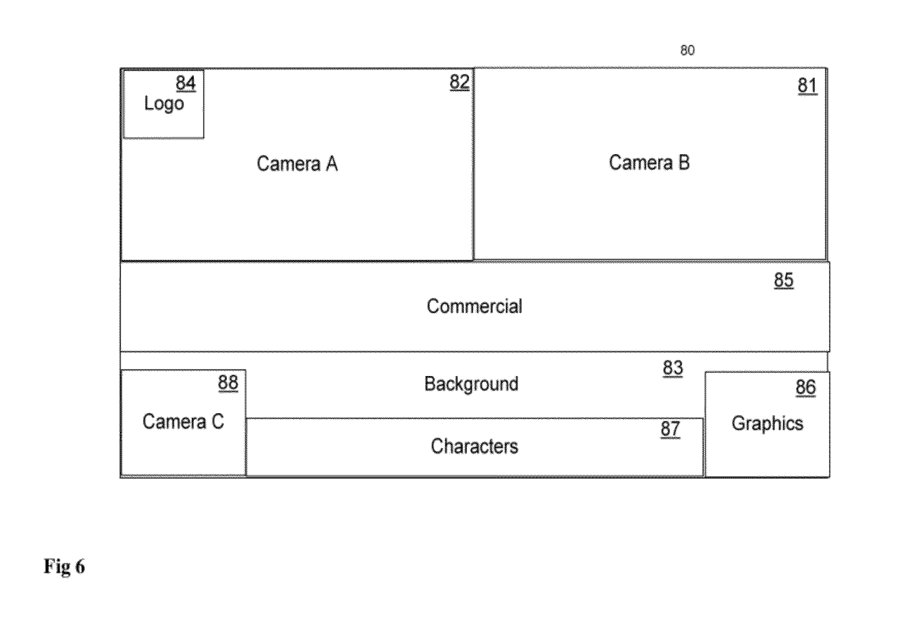

FIG. 6 is an example of one combination of display elements or compound display that an operator 301 could build from the various video sources available. The full display 80 may be divided into a plurality of panes to simultaneously show images captured by camera A in one section 82, images from camera B in a different section 81, and images from camera C 88 on top of a background 83. A logo 84, video commercial 85, characters 87 and graphics 86 may be added using the appropriate components and from the appropriate databases as described hereinabove with reference to FIG. 5. Other cameras, logos, graphic elements commercials and character sections may be provided and each of the displays may include these elements in different sizes and locations as decided by the operators.

It will be appreciated that the Figures and above description describe a generalized system, which may be embodied in a number of ways. The data links shown may be hard wired or wireless.

In the claims, the word “comprise”, and variations thereof such as “comprises”, “comprising” and the like indicate that the components listed are included, but not generally to the exclusion of other components.

What is claimed is:

1. An operator's control room coupled via a data link to a network control room, said operator's control room for enabling one or more operators to control the network control room via at least one operator input output device coupled to at least one control unit.

2. The operator's control room of claim 1, further comprising at least one of the group comprising a headphone, a camera, a display, an audio codec, a video codec, a data module, and a communication module.

3. A system comprising a network control room accessible via a data link by a control room operator operating an operator's control room comprising input-output equipment, for generating audiovisual data streams for reception by enabled viewing devices over a network.

4. The system of claim 3, wherein the operator's control room is for enabling one or more operators to control the network control room via at least one operator input output device coupled to at least one control unit.

5. The system of claim 3, wherein the network is an Internet.

6. The system of claim 3, wherein the network control room is either supported at a single location or is distributed over a plurality of data centers.

7. The system of claim 3, wherein functional components are coupled by data links selected from the group comprising fiber-optic lines, copper lines, coaxial cables, radio channels, cellular channels, satellite channels IR and RF links.

8. The system of claim 3, wherein the network control room is configured for accessing data from at least one video content archive.

9. The system of claim 8, wherein the video content archive is configured to provide data selected from the group comprising audio visual data, display information and supplementary information.

10. The system of claim 3 further comprising at least one video camera selected from the group comprising studio cameras, home cameras, field cameras.

11. The system of claim 3 wherein audiovisual, audio and visual data is provided in at least one format selected from the group comprising ca streams and data files.

12. The system of claim 11 wherein audiovisual, audio and visual data is provided compressed or uncompressed.

13. The system of claim 3 wherein the network control room is in data communication with and able to access commercial content from a commercial content archive.

14. The system of claim 3, further comprising a television studio comprising at least some of the group comprising media processing units, prompters, monitors, speakers, earphones, and lighting.

15. The system of claim 15 wherein the media processing unit is in data communication with at least one of the group comprising studio cameras and microphones and comprises a communication module in data communication with one or more video encoders, audio encoders, video decoders, audio decoders and controllers.

16. The system of claim 3 wherein the network control room comprises at least one communication module coupled via video and audio codecs to video and audio mixers, controllers, recorders, encoders, distributers, graphic effect generators, local content storage modules, and character generators.

17. The system of claim 3, further comprising an operator's control room coupled via a data link to the network control room, said operator's control room for enabling at least one operator to control the system, via at least one operator input output device selected from the group comprising keyboards, computer mice, touch screens, displays, cameras with gestures, 3d devices and light indicators, wherein the at least one operator input output device is coupled to at least one control unit.

18. The system of claim 17, wherein the operator's control room further comprises at least one of the group comprising headphones, cameras, displays, audio codecs, video codecs, data modules and communication modules.

19. A TV studio for control over a network from a network control room, the TV studio comprising at least some of the group comprising a media processing unit, a prompter, a monitor, a speaker, an earphone and lighting.

20. The TV studio of claim 19, wherein the media processing unit is in data communication with at least one of the group comprising studio cameras and microphones.
